(19) United States
(12) Patent Application Publication
(10) Pub. No.: US 2006/0154018 A1
(43) Pub. Date: Jul. 13, 2006

(54) Rug assembly

(76) Inventor: Fu-Pao Tsai, Chio Yi Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/033,148

(22) Filed: Jan. 12, 2005

(51) Int. Cl. B32B 3/06

(52) U.S. Cl. 428/99; 428/172; 428/167

(57) ABSTRACT

A rug assembly includes a base portion having a plurality of dust collection grooves defined in a top surface thereof and a plurality anti-slip bosses extend from an underside of the base portion. A durable plate such as a metal plate is fixed to the top surface of the base portion. The durable plate has a plurality of protrusions extending from a top surface thereof.

### FIELD OF THE INVENTION

The present invention relates to a rug assembly which includes a durable plate fixed on a top surface thereof and the durable plate includes protrusions for easily remove foreign objects on shoe soles.

### BACKGROUND OF THE INVENTION

A conventional rug is used to put in front of the entrance and generally includes rough top surface so that when people scrub their shoes on the rough top surface to remove foreign objects such as grass or pebbles before stepping into the entrance. Conventional rugs include printed patterns on the top surface and the printed patterns are easily removed by frequent scrubbing and once the printed patterns are removed, the users often complain the quality of the rugs. Besides, the area that the shoes often scrub tends to become a recessed area which cannot scrub the shoe soles as expected.

The present invention intends to provide a rug assembly that includes a durable plate fixed on the top surface and protrusions extend from the durable plate so that the foreign objects on the shoe soles can be easily removed and the durable plate is not easily deformed.

### SUMMARY OF THE INVENTION

The present invention relates to a rug assembly that comprises a base portion having a plurality of dust collection grooves defined in a top surface thereof and a plurality anti-slip bosses extending from an underside of the base portion. A durable plate is fixed to the top surface of the base portion and has a plurality of protrusions extending from a top surface thereof.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the rug assembly of the present invention;

FIG. 2 is an exploded view to show the base portion and the durable plate of the rug assembly of the present invention;

FIG. 3 shows the underside of the rug assembly of the present invention;

FIG. 4 shows a cross sectional view of the connection of the durable plate and the base portion of the rug assembly of the present invention;

FIG. 5 shows that the durable plate is fixed to another position on the base portion;

FIG. 6 shows another embodiment of the durable plate;

FIG. 7 shows the base portion is composed of two parts;

FIG. 8 shows a cross sectional view of the connection of the durable plate and the base portion in FIG. 7, and

FIG. 9 shows the durable plate is fixed to a carpet.

### DETAILED DESCRIPTION OF THE PREFERRED EMBODIMENT

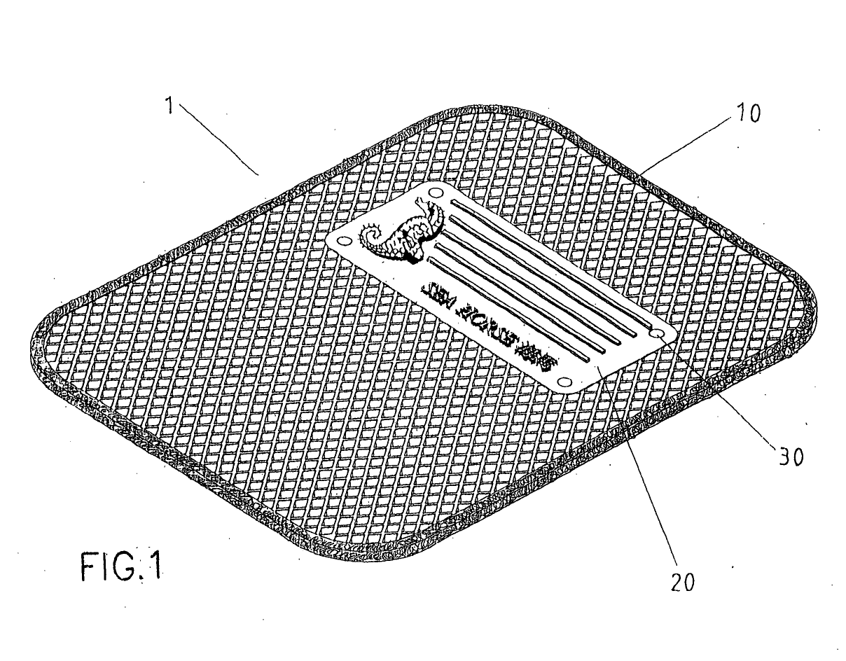

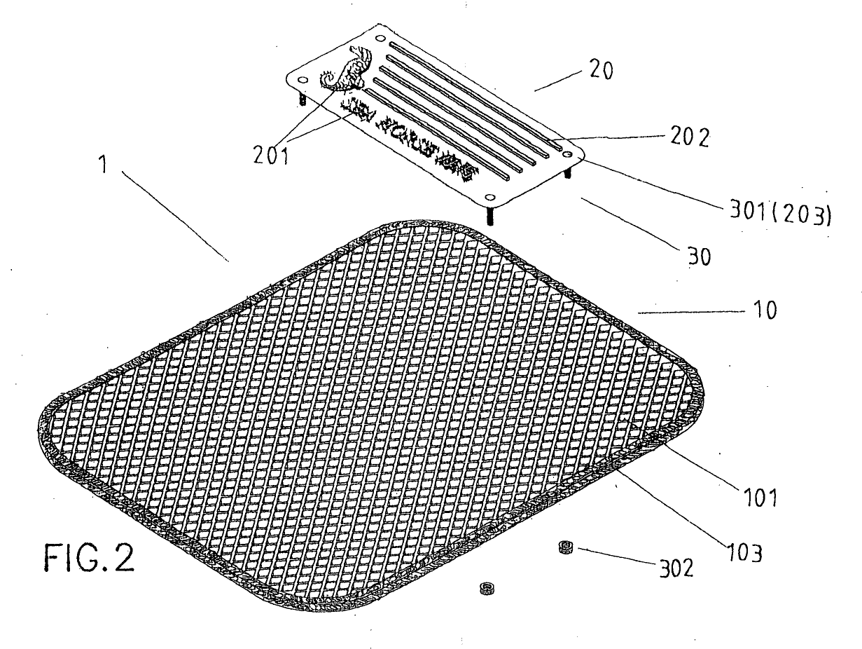

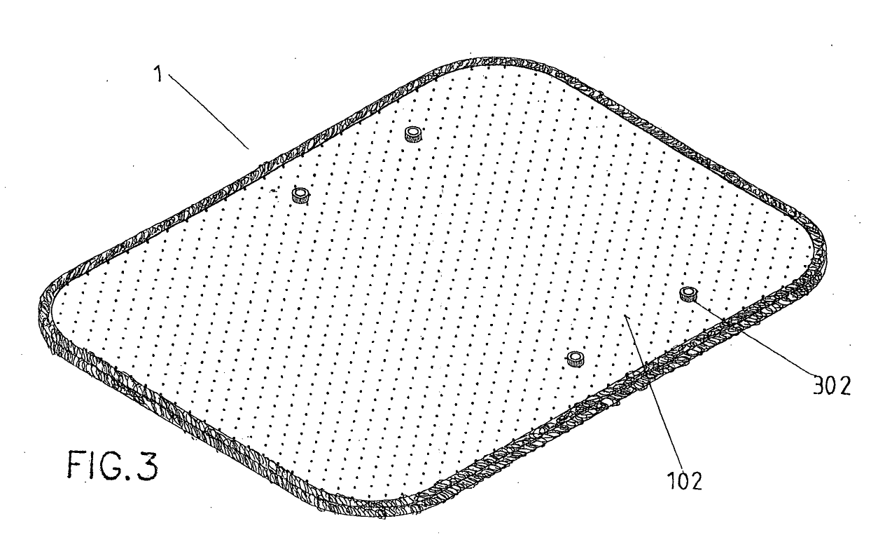

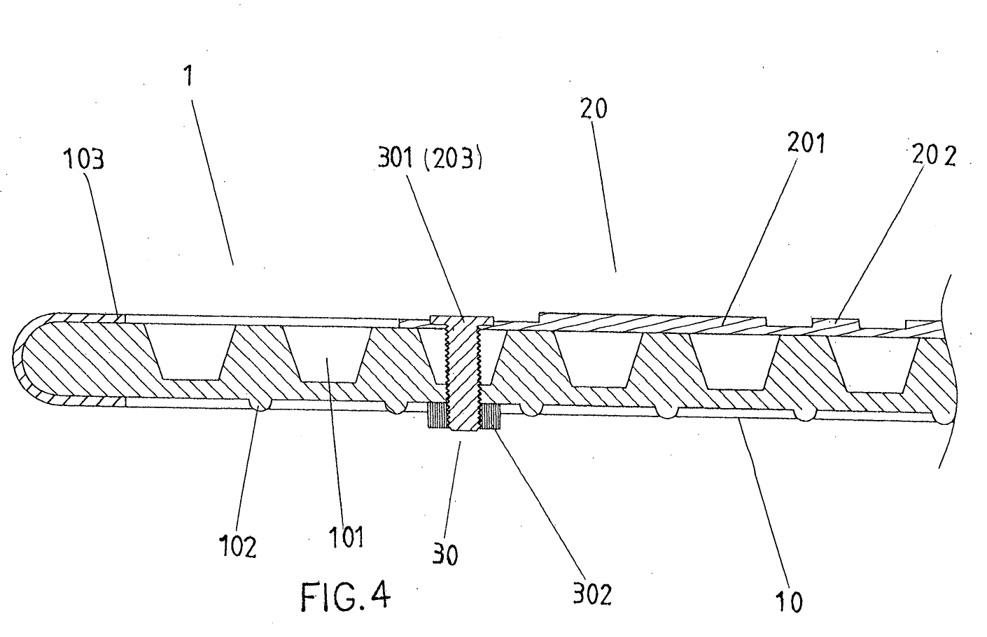

Referring to FIGS. 1 to 4, the rug assembly 1 of the present invention comprises a base portion 10 having a plurality of dust collection grooves 101 defined in a top surface thereof and a plurality anti-slip bosses 102 extend from an underside of the base portion 10. A durable plate 20 can be a metal plate and is fixed to the top surface of the base portion 10 by a fastening device 30. A plurality of protrusions 202 extend from a top surface of the durable plate 20 so as to form a rough surface for removing foreign objects on shoe soles when the shoe soles scrub on the durable plate 20. The protrusions 202 perform as anti-slip surface also. At least one pattern 201 is formed on the top surface of the durable plate 20 and can be convex patterns.

The durable plate 20 has holes 203 defined through four corners thereof and the fastening device 30 includes four screws 301 which extend through the holes 203 and the base portion 10 and are connected with nuts 302 at the underside of the base portion 10.

A Velcro member 103 is connected to a periphery of the base portion 10 such that multiple base portions 10 can be combined with each other to form a larger area.

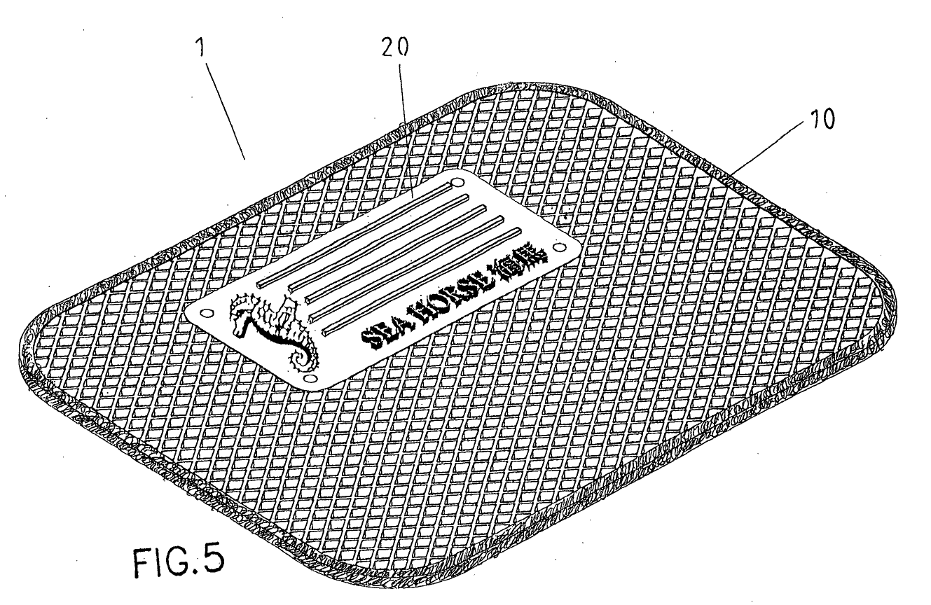

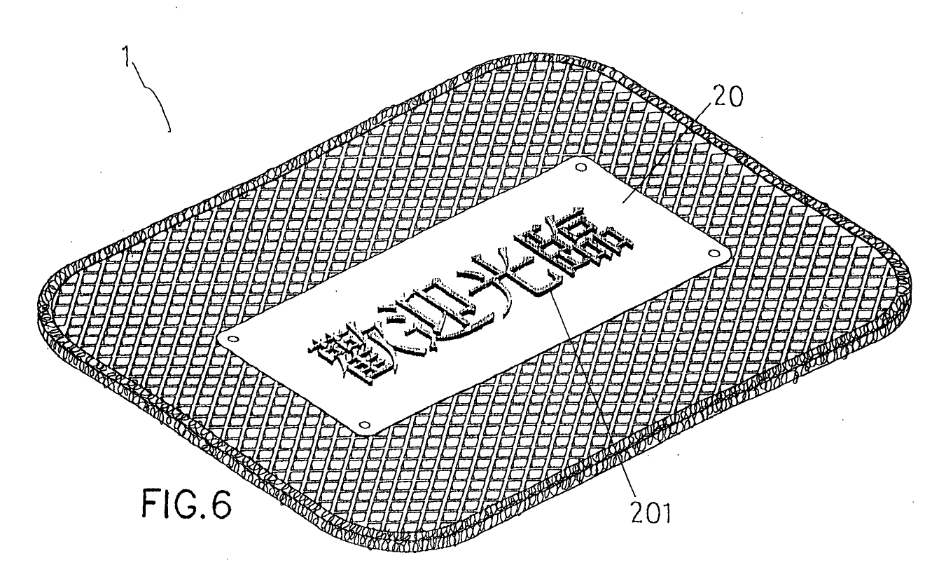

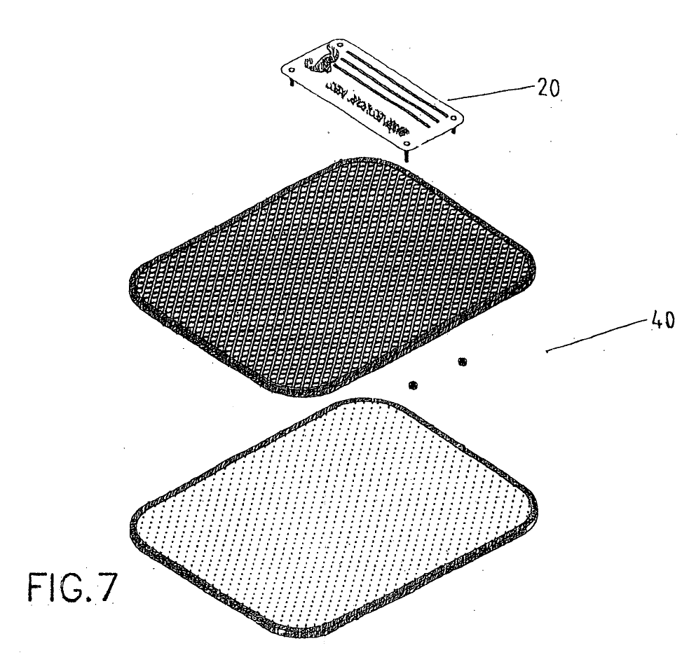

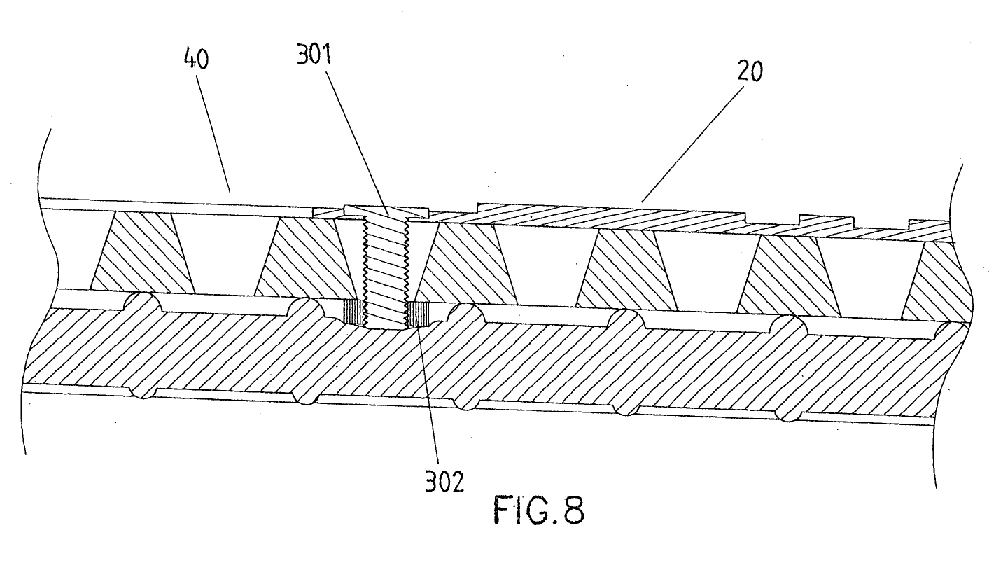

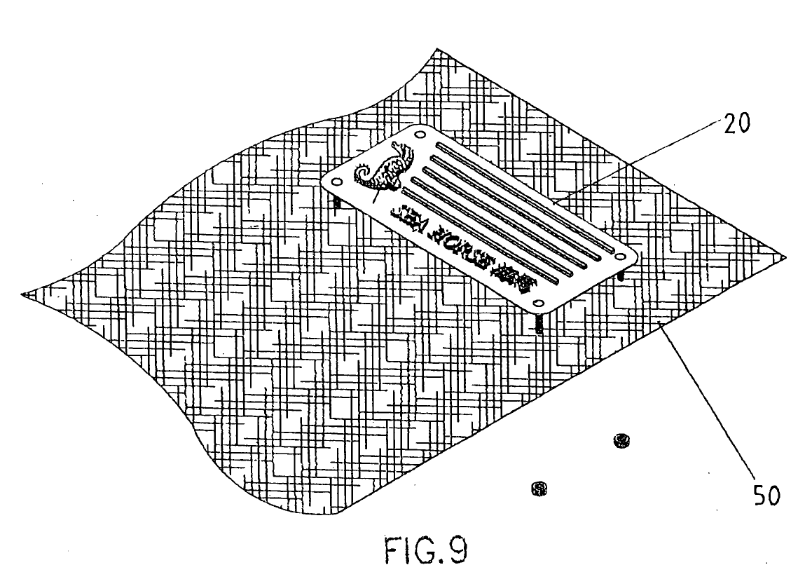

FIGS. 5 and 6 show that the durable plate 20 can be fixed to a desired position on the base portion 10 and the size of the durable plate 20 can be set as desired. FIGS. 7 and 8 show that the base portion 40 is composed of two parts and the screws extend through the top one of the two parts and the nuts 302 are sandwiched between the two parts. The durable plate 20 can also be fixed on a carpet 50 as shown in FIG. 9.

While we have shown and described the embodiment in accordance with the present invention, it should be clear to those skilled in the art that further embodiments may be made without departing from the scope of the present invention.

What is claimed is:

1. A rug assembly comprising:
a base portion having a plurality of dust collection grooves defined in a top surface thereof, a plurality anti-slip bosses extending from an underside of the base portion, and
a durable plate having a plurality of protrusions extending from a top surface thereof and the durable plate being fixed to the top surface of the base portion.

2. The assembly as claimed in claim 1, wherein the durable plate has holes defined therethrough and screws extend through the holes and the base portion and are connected with nuts at the underside of the base portion.

3. The assembly as claimed in claim 1, wherein at least one pattern is formed on the top surface of the durable plate.

4. The assembly as claimed in claim 1, wherein the durable plate is a metal plate.

5. The assembly as claimed in claim 1, wherein a Velcro member is connected to a periphery of the base portion.

6. The assembly as claimed in claim 1, wherein the base portion is composed of two parts and the screws extend through a top one of the two parts and the nuts are sandwiched between the two parts.
